(19) United States
(12) Patent Application Publication
(10) Pub. No.: US 2026/0051992 A1
(43) Pub. Date: Feb. 19, 2026

(54) Reduced Pilot Transmission and Channel Estimation

(71) Applicant: Dell Products L.P., Round Rock, TX (US)

(72) Inventors: Eran Goldstein, Montreal (CA); Mohammed Abdelsadek, Kanata (CA); Jayaram Venguduswamy Srinivasan, Nepean (CA)

(21) Appl. No.: 18/804,974

(22) Filed: Aug. 14, 2024

(51) Int. Cl. H04L 5/00; H04L 1/00; H04L 25/02; H04W 72/231

(52) U.S. Cl. CPC H04L 5/0051; H04L 1/0061; H04L 25/0202; H04W 72/231

(57) ABSTRACT

A system can, based on determining that a radio frequency channel of broadband cellular communications, facilitated by the system with at least one user equipment, satisfies a criterion with respect to a rate of change relative to a gap between demodulation reference signal transmissions, indicate, to the user equipment via a physical downlink control channel, to use a channel estimation with respect to a resource block that was made prior to transmitting the resource block, and transmit the resource block, wherein the resource block omits demodulation reference signal information.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, based on determining that a radio frequency channel of broadband cellular communications, facilitated by the system with at least one user equipment, satisfies a criterion with respect to a rate of change relative to a gap between demodulation reference signal transmissions, indicate, to the user equipment via a physical downlink control channel, to use a channel estimation with respect to a resource block that was made prior to transmitting the resource block, and transmit the resource block, wherein the resource block omits demodulation reference signal information.

An example method can comprise determining, by a system comprising at least one processor, that a radio frequency channel of broadband cellular communications with at least one user equipment satisfies a criterion with respect to a rate of change relative to a gap between demodulation reference signal transmissions. The method can further comprise indicating, by the system to the user equipment via a physical downlink control channel, to use a channel estimation with respect to a resource block that was made prior to transmitting the resource block. The method can further comprise transmitting, by the system, the resource block, wherein the resource block omits demodulation reference signal information.

An example non-transitory computer-readable medium can comprise instructions that, in response to execution, cause a system comprising a processor to perform operations. These operations can comprise indicating, to a user device via a physical downlink control channel of broadband cellular communications, to use a channel estimation with respect to a resource block that was made prior to transmitting the resource block. These operations can further comprise transmitting the resource block, wherein the resource block excludes demodulation reference signal information.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate reduced pilot transmission and channel estimation, in accordance with an embodiment of this disclosure;

FIG. 2 illustrates an example of using reduced pilot transmission in channel estimation, in accordance with an embodiment of this disclosure;

FIG. 3 illustrates an example process flow for reduced pilot transmission and channel estimation, in accordance with an embodiment of this disclosure;

FIG. 4 illustrates another example process flow for reduced pilot transmission and channel estimation, in accordance with an embodiment of this disclosure;

FIG. 5 illustrates another example process flow for reduced pilot transmission and channel estimation, in accordance with an embodiment of this disclosure;

FIG. 6 illustrates another example process flow for reduced pilot transmission and channel estimation, in accordance with an embodiment of this disclosure;

FIG. 7 illustrates another example process flow for reduced pilot transmission and channel estimation, in accordance with an embodiment of this disclosure;

FIG. 8 illustrates another example process flow for reduced pilot transmission and channel estimation, in accordance with an embodiment of this disclosure;

FIG. 9 illustrates another example process flow for reduced pilot transmission and channel estimation, in accordance with an embodiment of this disclosure;

FIG. 10 illustrates another example process flow for reduced pilot transmission and channel estimation, in accordance with an embodiment of this disclosure; and

FIG. 11 illustrates an example block diagram of a computer operable to execute an embodiment of this disclosure.

### DETAILED DESCRIPTION

### Overview

While the examples herein generally relate to fifth generation (5G) new radio (NR) broadband cellular communications, it can be appreciated that they can be applied to other types of communications, such as those made according to a Long-Term Evolution (LTE) or sixth generation (6G) broadband cellular communications.

In 5G NR numerology, a 10 millisecond (ms) radio frame can be divided into ten subframes, each is composed of a number of slots depending on the used subcarrier spacing. For example, for a 30 kilohertz (kHz) subcarrier spacing, the radio frame can be composed of 20 slots, each of 0.5 ms. These slots can be considered independent from the scheduling perspective, and can be referred to as transmission time intervals (TTIs). That is, each slot can contain the coded transport payload and the reference signals used for the demodulation of such data. This can mainly be for data channels (that is, physical downlink shared channel (PDSCH) and physical uplink shared channel (PUSCH)) that use demodulation reference signals (DMRS) to estimate the channel at the receiver side and use that estimation to equalize the data symbols.

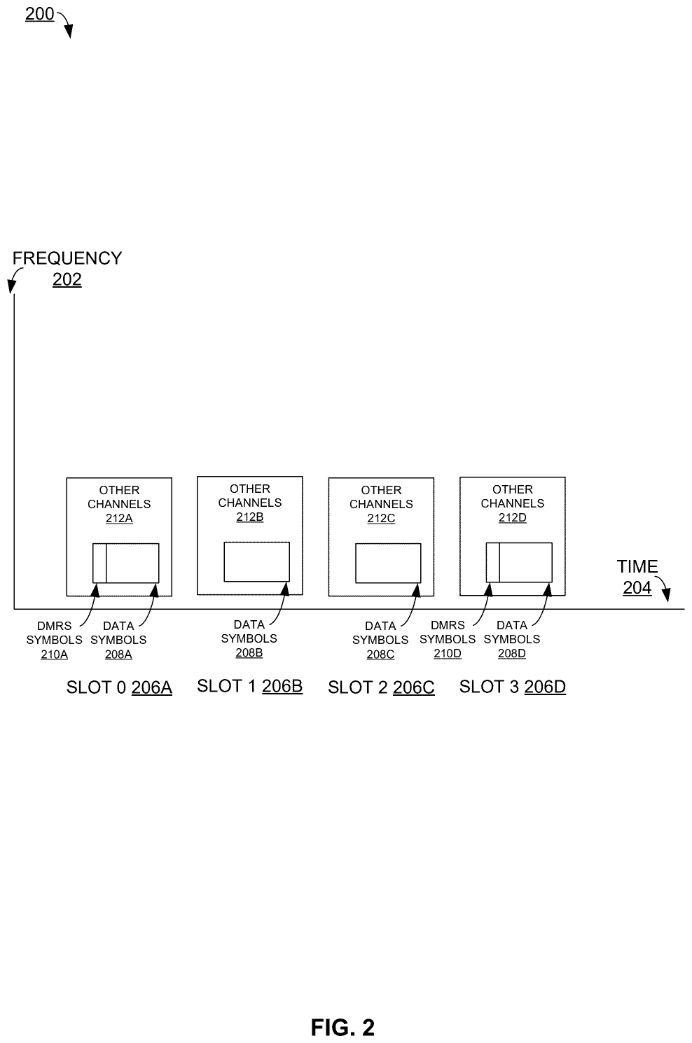

A 3rd Generation Partnership Project (3GPP) standard can provide for dynamically configuring the number of DMRS symbols per slot, starting from one symbol and up to a total of four DMRS symbols. This is illustrated in FIG. 2. It can be that the number of DMRS symbols cannot be set to zero. The configured number of DMRS symbols can depend on the channel variation rate. For example, in high varying channel conditions (that is, when the coherence time interval is short), four DMRS symbols can be used to enable the receiver to accurately estimate the channel. On the other hand, if the channel is changing slowly, it can be that one DMRS symbol is sufficient to represent the channel, along with 14 orthogonal frequency division multiplexing (OFDM) symbols in the slot, as the higher number can decrease spectral efficiency.

The present techniques can be implemented to facilitate improving the performance of the following two use cases:
1. Ultra-Reliable Low Latency Communications (URLLC): In some URLLC scenarios, the total number of symbols used for transmission can be quite small, reaching as low as 2 symbols.
2. Fixed Wireless Access (FWA): A FWA scenario can be characterized with almost no change in the channel condition on slot-to-slot basis.

According to a 3GPP standard, a minimum of one DMRS symbol must be used to enable channel estimation at the receiver side even if the channel is stable and the coherence interval is relatively long (e.g., in FWA and dominant line of sight (LoS) cases). This can be because each slot is scheduled independently and must have its reference signal. However, it can be that each DMRS occupies most of the allocated OFDM symbol or occupies all its subcarriers in some cases (e.g., if several layers are used or if data are not allowed inside a DMRS symbol). This can reduce a number of resource elements (REs) available for data transmission. Consequently, spectral efficiency is degraded.

More specifically, in the following use cases, the DMRS symbols can reduce spectral efficiency, increase power consumption, and increase latency:

### URLLC:

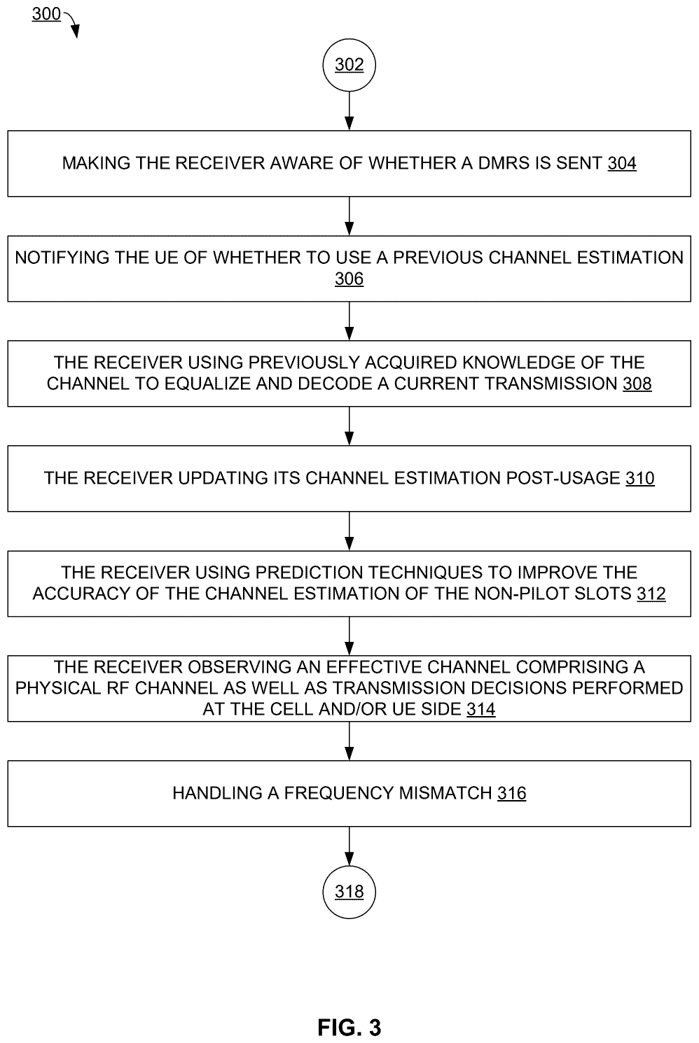

The lower the number of symbols used for transmission, the higher the percentage of the transmission is dedicated for pilot transmissions (and not for data). For example, in the extreme case of 2 symbols transmission, one of the 2 symbols is used for pilots and around 50% of the resources are not used for data (see FIG. 3).
The user equipment (UE) and gNodeB (gNB, sometimes referred to as a base station) can respond quickly to low-latency transmissions, and a portion of Level 1 (L1) latency budget can be taken for channel estimation. The processing time of channel estimation can be reduced to improve the total latency.

### FWA:

In fixed wireless scenarios, the radiofrequency (RF) channel normally changes slowly over time. In these cases, the DMRS can be redundant, as the previous channel estimation and/or its prediction might be sufficient to estimate the current channel estimation. Using those resources instead for data can increase spectral efficiency.

In both use cases above, the reduction in spectral efficiency can also be translated into increased power consumption. If the communication can be done without the DMRS symbols, it can be less power can be transmitted, and consequently, less RF power can be wasted, which can be the biggest power consumer of the network system.

The present techniques can be implemented to facilitate the following, relative to prior approaches:
1. Non-pilot scheduling.
2. Update channel model based on verified data (e.g., CRC) at the receiver side.
3. Phase and frequency updates based on adjacent channels.
4. Phase and frequency updates based on data least square match to constellation.

### Example Architectures

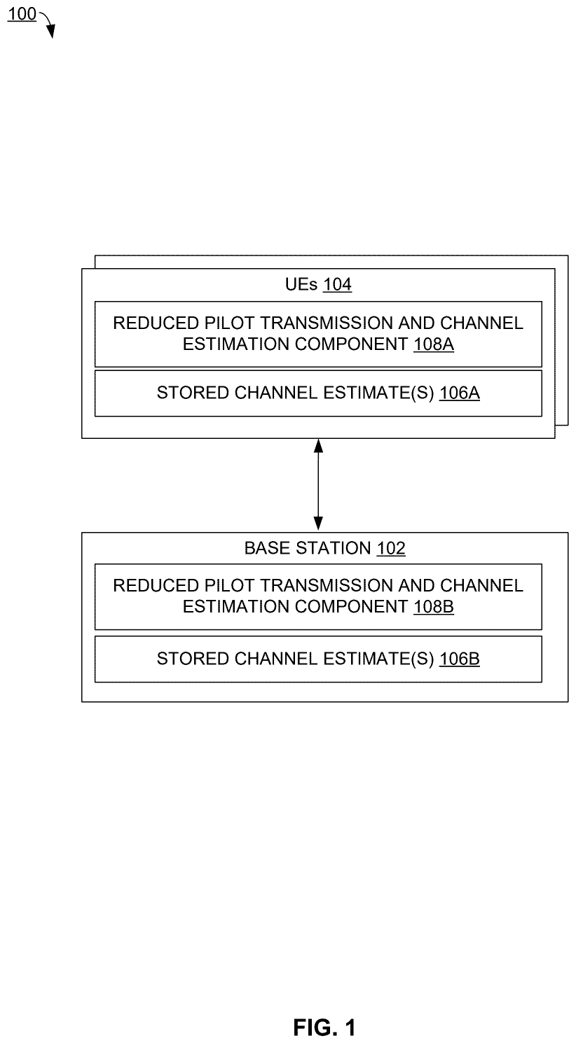

FIG. 1 illustrates an example system architecture 100 that can facilitate reduced pilot transmission and channel estimation, in accordance with an embodiment of this disclosure.

System architecture 100 comprises base station 102 and UEs 104. In turn, base station 102 comprises stored channel estimate(s) 106B and reduced pilot transmission and channel estimation component 108B; and at least one UE of UEs 104 comprises stored channel estimate(s) 106A and reduced pilot transmission and channel estimation component 108A.

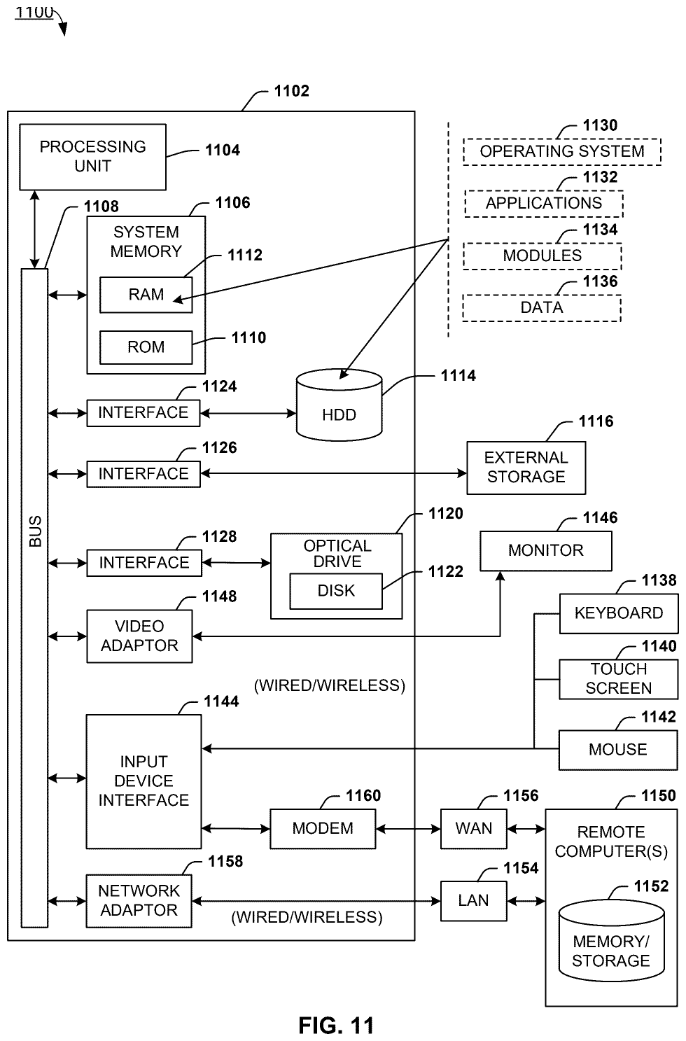

Each of base station 102 and/or UEs 104 can be implemented with part(s) of computing environment 1100 of FIG. 11.

Base station 102 can conduct broadband cellular communications with a UE of UEs 104. In doing so, reduced pilot transmission and channel estimation component 108B can determine whether to send DMRS. In some situations (e.g., a fixed wireless scenario where a RF channel changes slowly), it can be determined that the previous channel estimation and/or its prediction can be sufficient to estimate the current channel estimation. In such situations, reduced pilot transmission and channel estimation component 108A can indicate to the UE that it is sending no DMRS in a subsequent transmission. Instead of using new DMRS to perform channel estimation, the UE can use a stored channel estimation from stored channel estimate(s) 106A. By not sending DMRS data, spectral efficiency can be increased because more of the transmission can be used for transmitting data compared to the non-zero DMRS transmission case.

The above describes a scenario where a UE of UEs 104 holds a channel estimation. In a similar scenario where base station 102 holds a channel estimation, reduced pilot transmission and channel estimation component 108A of a UE of UEs 104 can determine whether to send DMRS, and can indicate to base station 102 that it is sending no DMRS in a subsequent transmission. Instead of using new DMRS to perform channel estimation, base station 102 can use a stored channel estimation from stored channel estimate(s) 106B.

In some examples, reduced pilot transmission and channel estimation component 108A and/or reduced pilot transmission and channel estimation component 108B can implement part(s) of the process flows of FIGS. 3-10 to facilitate reduced pilot transmission and channel estimation.

It can be appreciated that system architecture 100 is one example system architecture for reduced pilot transmission and channel estimation, and that there can be other system architectures that facilitate reduced pilot transmission and channel estimation.

FIG. 2 illustrates an example 200 of using reduced pilot transmission in channel estimation, in accordance with an embodiment of this disclosure. In some examples, part(s) of example 200 can be used by part(s) of system architecture 100 of FIG. 1 to facilitate reduced pilot transmission in channel estimation.

System architecture 200 comprises frequency 202, time 204, slot 0 206A, slot 1 206B, slot 2 206C, slot 3 206D, data symbols 308A, data symbols 308B, data symbols 308C, data symbols 308D, DMRS symbols 310A, DMRS symbols 310D, other channels 312A, other channels 312B, other channels 312C, and other channels 312D.

In example 200, slot 1 206B and slot 2 206C omit DMRS symbols (between a cell and a UE), as according to the present techniques. In this situation, a receiver can perform channel estimation based on previously-received DMRS symbols.

### Example Process Flows

FIG. 3 illustrates an example process flow 300 for reduced pilot transmission and channel estimation, in accordance with an embodiment of this disclosure. In some examples, one or more embodiments of process flow 300 can be implemented by system architecture 100 of FIG. 1, or computing environment 1100 of FIG. 11.

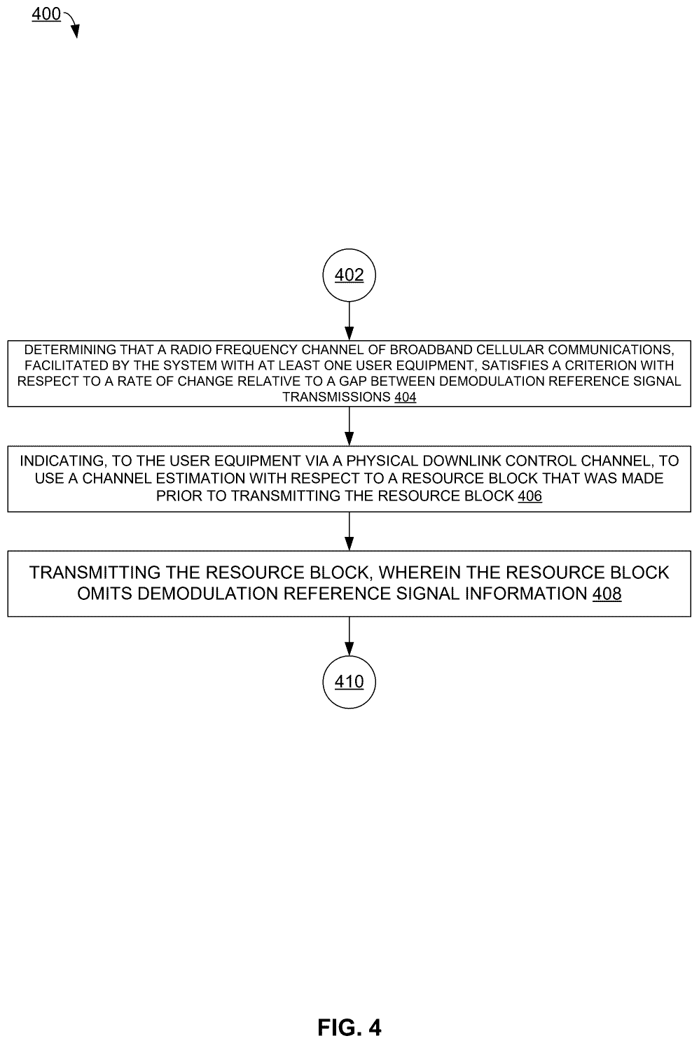

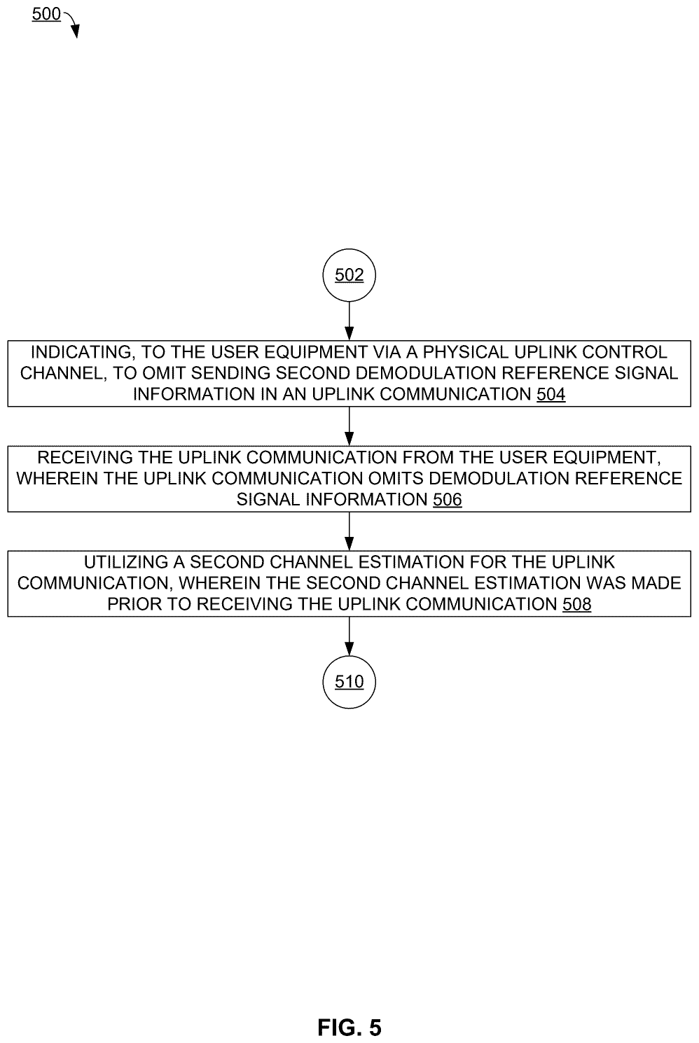

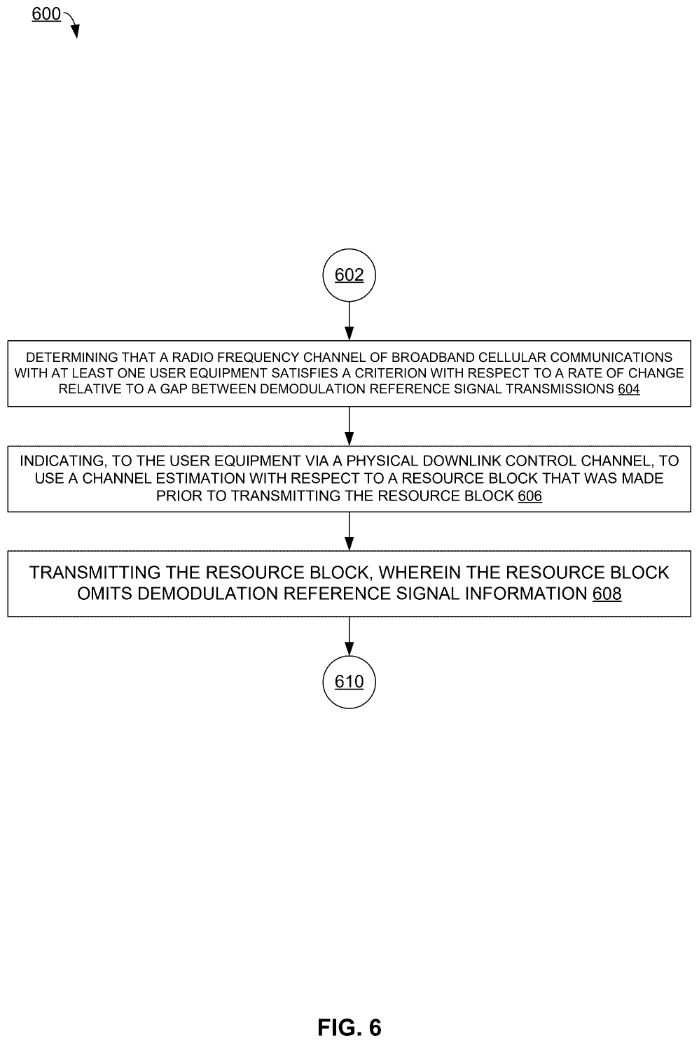

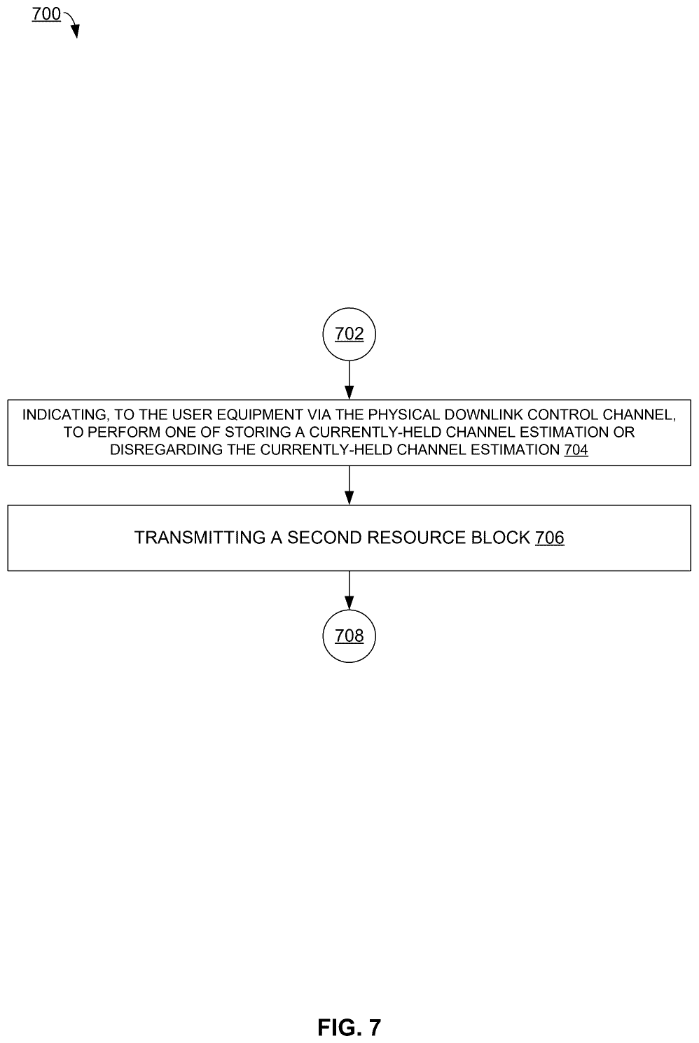

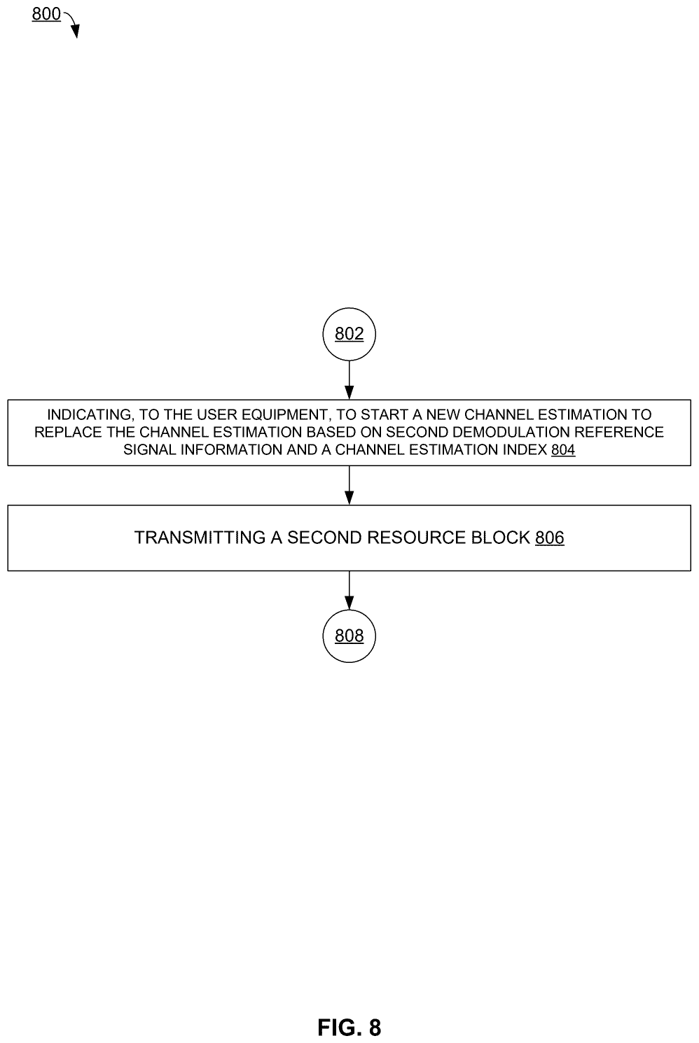

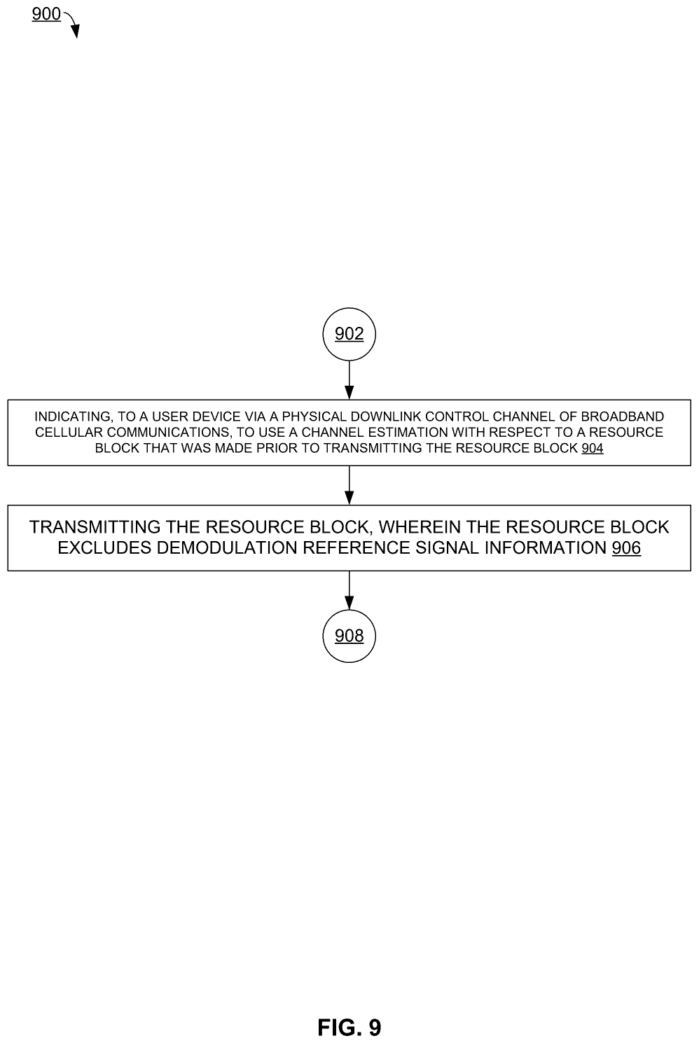

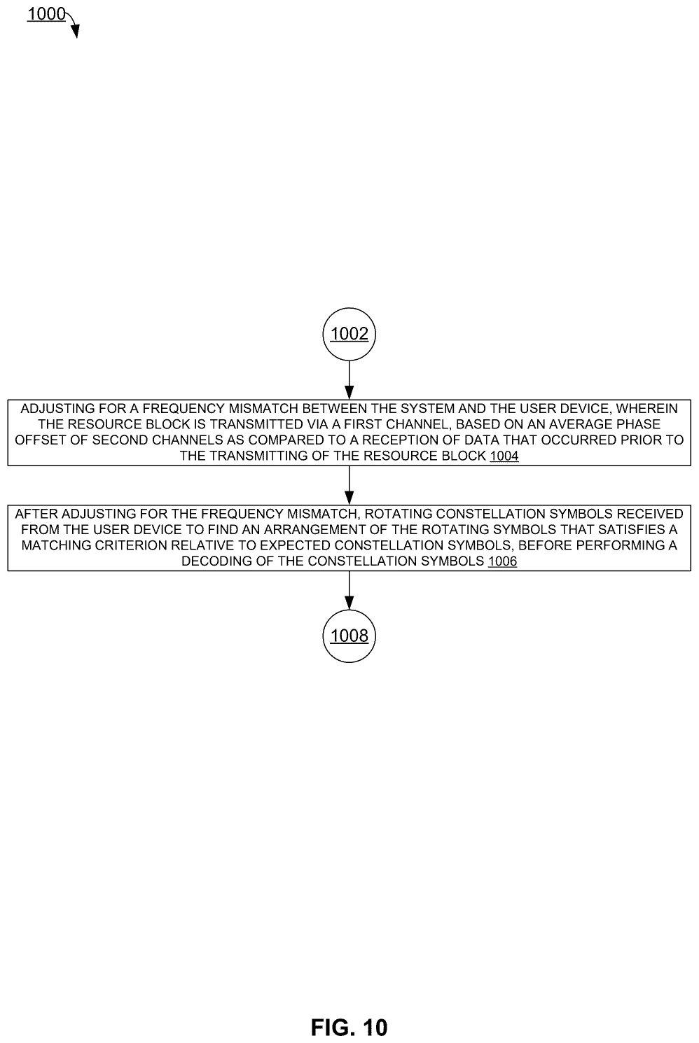

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 300 begins with 302, and moves to operation 304.

Operation 304 depicts making the receiver aware of whether a DMRS is sent.

After operation 304, process flow 300 moves to operation 306.

Operation 306 depicts notifying the UE of whether to use a previous channel estimation.

After operation 306, process flow 300 moves to operation 308.

Operation 308 depicts the receiver using previously acquired knowledge of the channel to equalize and decode a current transmission.

After operation 308, process flow 300 moves to operation 310.

Operation 310 the receiver updating its channel estimation post-usage.

After operation 310, process flow 300 moves to operation 312.

Operation 312 depicts the receiver using prediction techniques to improve the accuracy of the channel estimation of the non-pilot slots.

After operation 312, process flow 300 moves to operation 314.

Operation 314 depicts the receiver observing an effective channel comprising a physical RF channel as well as transmission decisions performed at the cell and/or UE side.

After operation 314, process flow 300 moves to operation 316.

Operation 316 depicts handling a frequency mismatch.

After operation 316, process flow 300 moves to 318, where process flow 300 ends.

This process flow is described in more detail as follows.

The present techniques can be implemented to facilitate a strategy to be used to reduce the number of the required DMRS symbols and techniques to address the consequences of that reduction.

An approach according to the present techniques can be to introduce an option to not transmit the DMRS symbols at selected time slots, such as in 3GPP communications. In those cases, the receiver can use the previous channel estimation to estimate that of the slots without DMRS. This can work when the RF channel is changing slowly compared to a gap between the DMRS transmissions. In this regard, and in some examples, the following procedure can be followed:
1. The receiver is made aware (e.g., notified in a downlink (DL) case) whether a DMRS is sent or not. In prior approaches, the number of OFDM symbols used for DMRS ranges from 1 to 4 in 5G. With the present techniques, an option of zero OFDM symbols can be introduced.
   a. The transmitter on the UE side can be notified to use DMRS or not (via a control channel).
2. The UE receiver can be notified whether to use previous channel estimation or not (via the control channel—PDCCH).
3. The receiver can use previously acquired knowledge of the channel to equalize and decode current transmission.
4. In addition, the receiver can update its channel estimation post-usage, even when no pilots were sent, by matching data to the expected data by the channel. For example, as in a turbo equalization algorithm, in the cases where a cyclic redundancy check (CRC) passes, the receiver can reconstruct the received signal based on the decoded channel and predicted channel estimation, and by comparing that to the received data, can identify the required updates to the channel prediction. This can prolong a time until an additional DMRS is needed, in some examples, and in some cases indefinitely.
5. In addition, the receiver can use prediction techniques to improve the accuracy of the channel estimation of the non-pilot slots.
6. The effective channel observed by the receiver can be composed of the physical RF channel as well as the transmission decisions performed at the cell side (and some at the UE side), such as:
   precoding techniques,
   antenna selection,
   power per channel configuration,
   time shift updates,
   frequency updates,
   antenna calibrations.
Communications according to a 5G standard can keep all this complexity hidden by demodulating the pilots (DMRS), in the same way as the data, and by that allowing the receiver side to find the relevant effective channel by performing estimation over the DMRS without considering all the factors mentioned above that do impact the channel as seen on the receiver side.
However, that can mean that even in a slow changing RF channel, a change in one of the factors can create an immediate large change on the effective channel as seen at the receiver side.
Some parameters can change from transmission to transmission such as precoding or antenna selection. To account for those factors, some or all of the following can be implemented, in various examples:
   The receiver would save a set of channel estimations.
   The transmitter would either use one of the configurations that are related to one of the channel estimations stored on the receiver side, or a configuration that is not up-to-date channel estimation is relevant for.
   The receiver is to be aware of whether the one of the currently held channel estimations are to be kept or if it is obsolete (messaged to the UE via the control channel).
   The receiver can also be aware of whether the DMRS is to be used for resetting and starting a new channel estimation, and to which index of the channel estimation would this refer.
   The number of channel estimation to be saved is left as a parameter to be optimized per use case in one or more embodiments.
   In addition, on the UL side, the UE decision of precoding, antenna selection and power settings can be known to the cell. Therefore, by using the UE sounding channel SRS (if configured) the cell can update the channel estimation for a change in precoding, without holding a set of multiple channel estimations.
7. To handle the frequency mismatch that can exist between transmitter and receiver, the following can be implemented:
   a. Usage of accompanying channels average phase offset as compared to previous reception to determine the global phase shift that has occurred. For that purpose, PUCCH and sounding reference signal (SRS) on uplink (UL), and PDCCH synchronization signal block (SSB) and channel status information reference signal (CSI-RS) on DL can be used.
   b. After equalization, the received constellation symbols can be rotated to find a best match (or satisfactory match, such as according to a best match criterion) to the expected constellation, before moving on to a decoding stage.

FIG. 4 illustrates an example process flow 400 for reduced pilot transmission and channel estimation, in accordance with an embodiment of this disclosure. In some examples, one or more embodiments of process flow 400 can be implemented by system architecture 100 of FIG. 1, or computing environment 1100 of FIG. 11.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of process flow 300 of FIG. 3, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts determining that a radio frequency channel of broadband cellular communications, facilitated by the system with at least one user equipment, satisfies a criterion with respect to a rate of change relative to a gap between demodulation reference signal transmissions. That is, a base station can determine that a UE will use a previous channel estimation as a channel estimation for slots without DMRS. An example scenario can be where a RF channel is changing slowly compared to the gap between the DMRS transmissions.

In some examples, the criterion with respect to the rate of change relative to the gap between demodulation reference signal transmissions is defined based on at least one of a precoding, an antenna selection, a power per channel configuration, a time shift update, a frequency update, or an antenna calibration. This can be implemented in a similar manner as operation 314 of FIG. 3.

After operation 404, process flow 400 moves to operation 406.

Operation 406 depicts indicating, to the user equipment via a physical

downlink control channel, to use a channel estimation with respect to a resource block that was made prior to transmitting the resource block. That is, a base station can notify the UE to use the previous channel estimation via a PDCCH.

After operation 406, process flow 400 moves to operation 408.

Operation 408 depicts transmitting the resource block, wherein the resource block omits demodulation reference signal information. In some examples, operations 406-408 can occur based on the determining of operation 404. That is, when the base station transmits a resource block to a UE that omits DMRS, the UE can use previously acquired knowledge of channel conditions to equalize and decode this transmission.

In some examples, the transmitting of the resource block comprises the user equipment updating the channel estimation. In some examples, the user equipment updating the channel estimation is performed based on matching data of the resource block to expected data of a channel via which the resource block is transmitted. This can be implemented in a similar manner as operation 310 of FIG. 3.

In some examples, the user equipment updating the channel estimation is performed based on a result of a prediction. This can be implemented in a similar manner as operation 312 of FIG. 3.

After operation 408, process flow 400 moves to 410, where process flow 400 ends.

FIG. 5 illustrates an example process flow 500 for reduced pilot transmission and channel estimation, in accordance with an embodiment of this disclosure. In some examples, one or more embodiments of process flow 500 can be implemented by system architecture 100 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 300 of FIG. 3, process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

In some examples where process flow 500 is implemented in conjunction with process flow 400 of FIG. 4, the demodulation reference signal information is first demodulation reference signal information, and the channel estimation is a first channel estimation.

Operation 504 depicts indicating, to the user equipment via a physical uplink control channel, to omit sending second demodulation reference signal information in an uplink communication. That is, a transmitter of the UE can be notified of whether or not to use DMRS, and this can be communicated via a control channel.

After operation 504, process flow 500 moves to operation 506.

Operation 506 depicts receiving the uplink communication from the user equipment, wherein the uplink communication omits demodulation reference signal information. This can be performed based on the indication of operation 504.

After operation 506, process flow 500 moves to operation 508.

Operation 508 depicts utilizing a second channel estimation for the uplink communication, wherein the second channel estimation was made prior to receiving the uplink communication. That is, a prior channel estimation can be used for this uplink communication that omits DMRS information.

After operation 508, process flow 500 moves to 510, where process flow 500 ends.

FIG. 6 illustrates an example process flow 600 for reduced pilot transmission and channel estimation, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 300 of FIG. 3, process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts determining that a radio frequency channel of broadband cellular communications with at least one user equipment satisfies a criterion with respect to a rate of change relative to a gap between demodulation reference signal transmissions. In some examples, operation 604 can be implemented in a similar manner as operation 404 of FIG. 4.

After operation 604, process flow 600 moves to operation 606.

Operation 606 depicts indicating, to the user equipment via a physical downlink control channel, to use a channel estimation with respect to a resource block that was made prior to transmitting the resource block. In some examples, operation 606 can be implemented in a similar manner as operation 406 of FIG. 4.

In some examples, the indicating to use the channel estimation results in the user equipment saving the channel estimation prior to the indicating. That is, a receiver can save a set of channel estimations.

After operation 606, process flow 600 moves to operation 608.

Operation 608 depicts transmitting the resource block, wherein the resource block omits demodulation reference signal information. In some examples, operation 608 can be implemented in a similar manner as operation 408 of FIG. 4.

In some examples, the transmitting of the resource block results in the user equipment updating a channel model based on a cyclic redundancy check of the resource block. That is a channel model can be updated based on verified data (e.g., a CRC) at a receiver side.

In some examples, the transmitting of the resource block results in the user equipment updating a phase or a frequency based on a second channel that is adjacent to a first channel via which the resource block is transmitted. That is, phase and frequency updates can be performed based on adjacent channels.

In some examples, the transmitting of the resource block results in the user equipment updating a phase or a frequency based on a least square match to a constellation. That is, phase and frequency updates can be performed based on a data least square match to a constellation.

In some examples, the transmitting of the resource block is based on a configuration that is stored by, and obtained from, the user equipment. That is, in some examples, the transmitter can either use one of the configurations that is related to one of the channel estimations stored on the receiver side, or a configuration that is not up-to-date and for which channel estimation is relevant.

In some examples, a number of channel estimations to be saved by the user equipment comprises a configurable parameter.

In some examples, operation 608 comprises updating the channel estimation based on sounding reference signal information received from the user equipment. That is, on the UL side, the UE decision of precoding, antenna selection, and power settings can be known to the cell. Therefore, by using the UE sounding channel SRS (if configured), the cell can update the channel estimation for a change in precoding, without holding a set of multiple channel estimations.

After operation 608, process flow 600 moves to 610, where process flow 600 ends.

FIG. 7 illustrates an example process flow 700 for reduced pilot transmission and channel estimation, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 300 of FIG. 3, process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

In some examples where process flow 700 is implemented in conjunction with process flow 600 of FIG. 6, the resource block is a first resource block.

Operation 704 depicts indicating, the user equipment via the physical downlink control channel, to perform one of storing a currently-held channel estimation or disregarding the currently-held channel estimation. That is, the receiver can be made aware of whether the one of the currently held channel estimations is to be kept or if it is obsolete. This can be messaged to a UE via the control channel.

After operation 704, process flow 700 moves to operation 706.

Operation 706 depicts transmitting a second resource block. How this resource block is processed can be determined based on whether it contains DMRS information, and whether the receiver stores a channel estimation (from operation 704).

After operation 706, process flow 700 moves to 708, where process flow 700 ends.

FIG. 8 illustrates an example process flow 800 for reduced pilot transmission and channel estimation, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

In some examples where process flow 800 is implemented in conjunction with process flow 600 of FIG. 6, the demodulation reference signal information is first demodulation reference signal information, and the resource block is a first resource block.

Operation 804 depicts indicating, to the user equipment, to start a new channel estimation to replace the channel estimation based on second demodulation reference signal information and a channel estimation index. That is, the receiver can be aware of whether the DMRS is to be used for resetting and starting a new channel estimation, and which index of the channel estimation this refers to.

After operation 804, process flow 800 moves to operation 806.

Operation 806 depicts transmitting a second resource block. How this resource block is processed can be determined based on whether it contains DMRS information, and whether the DMRS is to be used for resetting and starting a new channel estimation (from operation 804).

After operation 806, process flow 800 moves to 808, where process flow 800 ends.

FIG. 9 illustrates an example process flow 900 for reduced pilot transmission and channel estimation, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts indicating, to a user device via a physical downlink control channel of broadband cellular communications, to use a channel estimation with respect to a resource block that was made prior to transmitting the resource block. In some examples, operation 904 can be implemented in a similar manner as operations 404-406 of FIG. 4.

After operation 904, process flow 900 moves to operation 906.

Operation 906 depicts transmitting the resource block, wherein the resource block excludes demodulation reference signal information. In some examples, operation 906 can be implemented in a similar manner as operation 408 of FIG. 4.

After operation 906, process flow 900 moves to 908, where process flow 900 ends.

FIG. 10 illustrates an example process flow 1000 for reduced pilot transmission and channel estimation, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts adjusting for a frequency mismatch between the system and the user device, wherein the resource block is transmitted via a first channel, based on an average phase offset of second channels as compared to a reception of data that occurred prior to the transmitting of the resource block. This can be implemented in a similar manner as operation 316 of FIG. 3.

After operation 1004, process flow 1000 moves to operation 1006.

Operation 1006 depicts, after adjusting for the frequency mismatch, rotating constellation symbols received from the user device to find an arrangement of the rotating symbols that satisfies a matching criterion relative to expected constellation symbols, before performing a decoding of the constellation symbols. This can be implemented in a similar manner as operation 316 of FIG. 3.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs 104 of FIG. 1.

In some examples, computing environment 1100 can implement one or more embodiments of the process flows of FIGS. 3-10 to facilitate reduced pilot transmission and channel estimation.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the. NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
based on determining that a radio frequency channel of broadband cellular communications, facilitated by the system with at least one user equipment, satisfies a criterion with respect to a rate of change relative to a gap between demodulation reference signal transmissions,
indicating, to the user equipment via a physical downlink control channel, to use a channel estimation with respect to a resource block that was made prior to transmitting the resource block, and
transmitting the resource block, wherein the resource block omits demodulation reference signal information.

2. The system of claim 1, wherein the demodulation reference signal information is first demodulation reference signal information, and wherein the operations further comprise:
indicating, to the user equipment via a physical uplink control channel, to omit sending second demodulation reference signal information in an uplink communication.

3. The system of claim 2, wherein the channel estimation is a first channel estimation, and wherein the operations further comprise:
receiving the uplink communication from the user equipment, wherein the uplink communication omits demodulation reference signal information; and
utilizing a second channel estimation for the uplink communication, wherein the second channel estimation was made prior to receiving the uplink communication.

4. The system of claim 1, wherein the transmitting of the resource block comprises the user equipment updating the channel estimation.

5. The system of claim 4, wherein the user equipment updating the channel estimation is performed based on matching data of the resource block to expected data of a channel via which the resource block is transmitted.

6. The system of claim 4, wherein the user equipment updating the channel estimation is performed based on a result of a prediction.

7. The system of claim 1, wherein the criterion with respect to the rate of change relative to the gap between demodulation reference signal transmissions is defined based on at least one of a precoding, an antenna selection, a power per channel configuration, a time shift update, a frequency update, or an antenna calibration.

8. A method, comprising:
determining, by a system comprising at least one processor, that a radio frequency channel of broadband cellular communications with at least one user equipment satisfies a criterion with respect to a rate of change relative to a gap between demodulation reference signal transmissions;
indicating, by the system to the user equipment via a physical downlink control channel, to use a channel estimation with respect to a resource block that was made prior to transmitting the resource block; and
transmitting, by the system, the resource block, wherein the resource block omits demodulation reference signal information.

9. The method of claim 8, wherein the transmitting of the resource block results in the user equipment updating a channel model based on a cyclic redundancy check of the resource block.

10. The method of claim 8, wherein the transmitting of the resource block results in the user equipment updating a phase or a frequency based on a second channel that is adjacent to a first channel via which the resource block is transmitted.

11. The method of claim 8, wherein the transmitting of the resource block results in the user equipment updating a phase or a frequency based on a least square match to a constellation.

12. The method of claim 8, wherein the indicating to use the channel estimation results in the user equipment saving the channel estimation prior to the indicating.

13. The method of claim 8, wherein the transmitting of the resource block is based on a configuration that is stored by, and obtained from, the user equipment.

14. The method of claim 8, further comprising:
indicating, by the system and to the user equipment via the physical downlink control channel, to perform one of storing a currently-held channel estimation or disregarding the currently-held channel estimation.

15. The method of claim 8, wherein the demodulation reference signal information is first demodulation reference signal information, and further comprising:
indicating, by the system and to the user equipment, to start a new channel estimation to replace the channel estimation based on second demodulation reference signal information and a channel estimation index.

16. The method of claim 8, wherein a number of channel estimations to be saved by the user equipment comprises a configurable parameter.

17. The method of claim 8, further comprising:
updating, by the system, the channel estimation based on sounding reference signal information received from the user equipment.

18. A non-transitory computer-readable medium comprising instructions that, in response to execution, cause a system comprising at least one processor to perform operations, comprising:
indicating, to a user device via a physical downlink control channel of broadband cellular communications, to use a channel estimation with respect to a resource block that was made prior to transmitting the resource block; and
transmitting the resource block, wherein the resource block excludes demodulation reference signal information.

19. The non-transitory computer-readable medium of claim 18, wherein the operations further comprise:
adjusting for a frequency mismatch between the system and the user device, wherein the resource block is transmitted via a first channel, based on an average phase offset of second channels as compared to a reception of data that occurred prior to the transmitting of the resource block.

20. The non-transitory computer-readable medium of claim 19, wherein the operations further comprise:
after adjusting for the frequency mismatch, rotating constellation symbols received from the user device to find an arrangement of the rotating symbols that satisfies a matching criterion relative to expected constellation symbols, before performing a decoding of the constellation symbols.
